(19) United States
(12) Patent Application Publication
(10) Pub. No.: US 2025/0109515 A1
(43) Pub. Date: Apr. 3, 2025

(54) SEPARATOR PLATE AND TOOL AND METHOD FOR PRODUCING A SEPARATOR PLATE

(71) Applicant: Reinz-Dichtungs-GmbH, Neu-Ulm (DE)

(72) Inventors: Andreas MICHALKE, Ulm (DE); Andreas RUOPP, Merklingen (DE); Wolfgang KRAUS, Neu-Ulm (DE); Manuel KAMM, Gannertshofen (DE); Alexander TRIPPEL, Senden-Wullenstetten (DE); Maxim VOVCUK, Neu-Ulm (DE); Hans WALDVOGEL, Krumbach (DE); Franz SCHWEIGGART, Pfaffenhofen (DE)

(21) Appl. No.: 18/900,250

(22) Filed: Sep. 27, 2024

(30) Foreign Application Priority Data
Sep. 28, 2023 (DE) 10 2023 209 565.3

(51) Int. Cl. C25B 13/02; C25B 13/05; C25B 13/08

(52) U.S. Cl. CPC C25B 13/02; C25B 13/05; C25B 13/08

(57) ABSTRACT

The present disclosure relates to a separator plate for an electrolyser, comprising
a metallic layer,
a first elastomer seal arranged in a first groove on a first side of the metallic layer, the first groove forming a first web on a second side of the metallic layer opposite the first side, and
a second elastomer seal arranged in a second groove on the second side, the second groove forming a second web on the first side.

The second web adjoins the first groove and the first web adjoins the second groove, so that the first groove and the second groove have a common side wall.

The first elastomer seal is spaced from the common side wall and is recessed in the region of the first groove.

The present disclosure further relates to a tool and a method for manufacturing the separator plate.

### CROSS REFERENCE TO RELATED APPLICATION

This application claims priority to German Patent Application No. 10 2023 209 565.3, entitled “SEPARATOR PLATE AND TOOL AND METHOD FOR PRODUCING A SEPARATOR PLATE”, filed Sep. 28, 2023. The entire contents of the above-identified application is hereby incorporated by reference for all purposes.

### TECHNICAL FIELD

The present disclosure relates to a separator plate for an electrolyser. Furthermore, the present disclosure relates to a tool and a method for manufacturing the separator plate.

### BACKGROUND AND SUMMARY

In general, electrolysers typically comprise a stack of individual electrochemical cells, each having a plurality of layers including at least one separator plate and a membrane electrode assembly (MEA), each individual cell being bounded by two adjacent separator plates. The stack of individual electrochemical cells can have two end plates that press the individual electrochemical cells together and give the stack stability. Furthermore, the individual electrochemical cells can comprise gas diffusion layers (GDL) or porous transport layers (PTL), which are arranged between the separator plate and the membrane electrode assembly. The separator plate can fulfill several functions: indirect electrical contacting of electrodes of the membrane electrode assembly (MEA), separation of media such as water, oxygen or hydrogen and electrical connection of the neighbouring individual electrochemical cells. The separator plate is often also referred to as a bipolar plate.

The separator plate comprises at least one through-opening (port) as an inlet or outlet for passing a fluid through the separator plate, a flow field with an electrochemically active region, and a fluid guide structure located therebetween for guiding the fluid between the through-opening and the flow field.

The separator plate can be single or multi-layered, for example. While separator plates in fuel cells are often double-layered so that cooling fluid can flow between the two individual layers, separator plates in electrolysers are usually single-layered as additional cooling is not necessary. The separator plate itself and each layer of a separator plate therefore separate the media.

In addition to the aforementioned separator plates, MEA, GDL or PTL, other layers can also be provided. Cell frames and/or cell seals can be arranged between adjacent separator plates to seal the cells. The stack of individual electrochemical cells must be sealed off from an external space, as a fluid or medium inside the individual electrochemical cells is often under excess pressure compared to the external environment. The fluid may, for example, comprise hydrogen, air (oxygen), water and/or mixture(s) thereof. In an electrolyser, the pressure difference between the environment and the inside of an electrochemical cell can often be more than 20 bar. For example, the pressure on the product side, for example the H₂ side, may be up to 40 bar, while the pressure on the reactant side, for example the H₂O side, is only up to 2 bar. It is therefore important to seal off the flow field of the fluid from the environment and also within the electrochemical system. For this purpose, the electrochemical system can have at least one cell frame running around the outer edge of the individual electrochemical cell for each of the individual electrochemical cells in order to achieve a sealing effect. In addition, the electrolyser can comprise one or more sealing layers or cell seals for each of the individual electrochemical cells in order to reinforce the sealing effect.

There is therefore a continuous need to further increase the tightness of the system, to prevent or at least reduce pressure loss or fluid loss and/or to increase the safety of the system.

In addition or as an alternative to the sealing layers, elastomer seals are often molded onto the separator plate in order to achieve or improve a sealing effect. Elastomer seals of this type are often arranged on both sides of the separator plate in order to seal both sides of the separator plate. The curing of the elastomer compound takes a long time, as the injected components have to cross-link. This cross-linking step is a very long individual process step in the overall manufacturing process of the separator plate, which can be disadvantageous in an industrial manufacturing process. Rather, it is desirable to inject both sides of the separator plate with elastomer compound in a single manufacturing step. However, due to the high injection pressure of often at least 500 bar, it is a challenge to seal the separator plate in the tool on both sides in order to prevent overmolding of the elastomer compound.

The object of the present disclosure is therefore to solve the above-mentioned problems at least in part.

This object is solved by the subject-matter of the independent claims.

According to a first aspect, a separator plate for an electrolyser is proposed. The separator plate comprises:
a metallic layer with a first side and a second side opposite the first side,
a first elastomeric seal arranged in a channel-shaped first groove on the first side of the metallic layer, wherein the first groove forms a first web on the second side of the metallic layer, and
a second elastomer seal which is arranged in a channel-shaped second groove on the second side of the metallic layer, wherein the second groove forms a second web on the first side of the metallic layer.

The second web is adjacent to the first groove and the first web is adjacent to the second groove, so that the first groove and the second groove have a common side wall. Here, the first elastomer seal is spaced from the common side wall and is recessed in the region of the first groove.

The described arrangement of elastomer seals is particularly compact and can be produced efficiently using a tool and method described below.

It may be provided that the floor of the first groove has an embossing in the region where the first elastomer seal is recessed, which extends in the longitudinal direction of the first groove next to the first elastomer seal. Furthermore, a roof of the first web can have an embossing, wherein the embossing of the web roof and the embossing of the groove floor are arranged to overlap, so that the metallic layer is thinner in the region of the overlapping embossings. For example, the metallic layer in the region of the embossing is at least 5%, 10% or 15% thinner and/or at most 40% thinner than in adjoining regions or in unembossed regions of the separator plate or the metallic layer. The above-mentioned embossings can result from the contact pressure of projections provided in a manufacturing tool, which are intended for sealing the separator plate in the tool during the manufacture of the separator plate, see below.

In some embodiments, the second elastomer seal is spaced from the common side wall and is recessed in this region of the second groove. Alternatively, the second elastomer seal can lie against the common side wall. It may be provided that the first groove is limited by a further side wall. The first elastomer seal can lie against the other side wall. Alternatively, the first elastomer seal can be spaced from the other side wall and recessed in this region.

Often, at least one of the two elastomer seals has at least one sealing lip, for example two sealing lips, which extends in the longitudinal direction of the elastomer seal and has a protrusion compared to the adjacent web. At least one of the elastomer seals or the sealing lip can define a sealing line or a sealing surface which extends around a region of the separator plate to be sealed. Adjoining the sealing lip, a depression can be formed in the elastomer seal, which extends laterally next to the sealing lip.

The first groove and the second groove can have different cross-sectional shapes. For example, the first groove and/or the second groove are essentially trapezoidal or rectangular in cross-section perpendicular to the longitudinal extension. The first elastomer seal often extends in the longitudinal direction of the first groove on a floor of the first groove. Furthermore, the second elastomer seal can extend in the longitudinal direction of the second groove on a floor of the second groove.

In addition to the first elastomer seal and the second elastomer seal, at least one further elastomer seal can be provided. For example, the separator plate has a third elastomer seal which is arranged in a channel-shaped third groove on the first side of the metallic layer, the third groove forming a third web on the second side of the metallic layer. It may be provided that the third web adjoins the second groove on the second side and the second web adjoins the third groove on the first side, so that the second groove and the third groove have a common side wall. The third elastomer seal is often spaced from the common side wall and recessed in this region. In some embodiments, the floor of the third groove has an embossing in the region where the third elastomer seal is recessed, which extends in the longitudinal direction of the third groove next to the third elastomer seal. A roof of the third web sometimes has an embossing, whereby the embossing of the web roof and the embossing of the groove floor are arranged to overlap, so that the metallic layer is thinner in the region of the overlapping embossings. These embossings can result from the manufacturing process of the separator plate, see below.

It can therefore be provided that the separator plate has at least one embossing along the longitudinal direction and next to the first elastomer seal and/or the second elastomer seal and/or the third elastomer seal. Two embossings can also be arranged on both sides of the respective elastomer seal.

It may be provided that where the separator plate has an elastomer seal, i.e. in the groove, the separator plate does not have an elastomer seal on its other side, i.e. on the web roof. The separator plate can therefore have alternating elastomer seals on its two flat sides. Nevertheless, different coatings can be provided on this other side, i.e. on the web roof.

The metallic layer of the separator plate is typically made of titanium and/or stainless steel. The metallic layer can have a thickness of at least 0.1 mm and/or at most 0.8 mm. The thickness of the metallic layer, as described above, can be lower in the region of the embossings than in the region next to the embossings. The separator plate is optionally configured as a single-layer separator plate and therefore, when used as intended, i.e. in the electrochemical system, only has the above-mentioned metallic layer. The separator plate can also be described as single-layered if an additional metallic part or insert is provided which is connected to the metallic layer, but which does not extend over the entire region of the metallic layer, but only locally over a region of at most 20% of the area of the metallic layer. Furthermore, the first elastomer seal and/or the second elastomer seal and/or the third elastomer seal can be formed from fluororubber, FKM, and/or ethylene-propylene-diene rubbers, EPDM and/or a silicone. The first elastomer seal and/or the second elastomer seal and/or the third elastomer seal are often injection-molded onto the metallic layer, for example in the process described below and/or using the injection tool described below.

The first side of the metallic layer is often configured as a high-pressure side, in particular the H₂ side, while the second side is configured as a low-pressure side, in particular the H₂O side.

The separator plate can have a flow field with an electrochemically active region. Furthermore, the separator plate can have at least one through-opening for the passage of a fluid. The first elastomer seal and/or the second elastomer seal and/or the third elastomer seal can be configured to seal the flow field and/or the through-opening at least in certain regions. The respective elastomer seal can be arranged around the flow field and/or the through-opening for this purpose, e.g. completely circumferentially.

According to a second aspect, a tool for manufacturing a separator plate is provided. The tool is configured to produce the separator plate described above and/or to carry out the method described below.

The tool includes:
a first tool component with a first injection channel for supplying a first elastomer compound, and
a second tool component with a second injection channel for supplying a second elastomer compound.

Of the tool components, at least one tool component can be moved relative to the other tool component, whereby the tool components are configured to receive the metallic layer in an open state and to inject the metallic layer on both sides in a closed state. The tool components are configured such that, in the closed state, a first cavity is formed between the first tool component and the first groove of the separator plate and a second cavity is formed between the second tool component and the second groove of the separator plate, wherein the first elastomer compound can be introduced into the first cavity from the first injection channel to form the first elastomer seal and the second elastomer compound can be introduced into the second cavity from the second injection channel to form the second elastomer seal.

The second tool half typically rests against the first web, while the first tool half usually rests against the second web of the separator plate. The abutting regions of the tool halves can be referred to as the contact regions of the corresponding tool halves. The contact regions can be configured as flat or essentially flat, possibly slightly concave or concave curved regions in the tool halves. The injection channels of the tool halves are often not arranged directly opposite each other (not overlapping), but alternately in the first tool half and the second tool half.

The first tool component may have a first projection and the second tool component may have a second projection, wherein the first projection and the second projection face each other. Facing each other here means in particular facing in the traversing direction of the tool components, which can also be described as facing in a vertical direction. The two projections are usually configured to clamp the metallic layer in the tool during the injection process and to locally seal the first cavity and/or the second cavity in order to impede overmolding of the elastomer compound. The first projection can adjoin the first cavity, while the second projection can adjoin the second cavity.

Usually, the two projections of the mutually-facing tool components are configured to locally thin out the metallic layer arranged between the projections. This local thinning results from the fact that the layer is clamped between the tool components and pressed between the two tool components. A minimum distance between the projections in the closing direction of the tool is often at least 10% less than the thickness of the metallic layer.

Features of the separator plate described above, for example the shape of the separator plate, can be combined with the tool and vice versa, provided they are not mutually exclusive. The separator plate, tool and method design according to the present disclosure is also suitable for anion exchange membrane electrolysis (AEM), for example for the conversion of CO₂.

According to a third aspect, a method of manufacturing a separator plate for an electrolyser, for example the separator plate of the type described above, is provided. The method comprises the steps:
providing a metallic layer having a first side and a second side opposite the first side, the metallic layer having a channel-shaped first groove on its first side, wherein the groove forms a first web on the second side of the metallic layer, wherein the metallic layer has on its second side a channel-shaped second groove which forms a second web on the first side of the metallic layer, wherein the second web adjoins the first groove and the first web adjoins the second groove, so that the first groove and the second groove have a common side wall,
inserting the metallic layer between a first tool component and a second tool component of a tool,
closing the tool,
forming a first cavity between the first groove and the first tool component and forming a second cavity between the second groove and the second tool component when the tool is in a closed state,
injecting an elastomer compound into the first cavity and into the second cavity from an injection channel located in each respective tool component, wherein the injection into the first cavity and the injection into the second cavity takes place in parallel, i.e. simultaneously, or at least partially in parallel,
forming the first elastomeric seal by curing the first elastomer compound in the first cavity associated with the first channel-shaped groove and the second elastomeric seal by curing the second elastomer compound in the second cavity associated with the second channel-shaped groove, wherein the first elastomeric seal is spaced from the common side wall and is recessed in this region of the first groove.

In one embodiment of the method, the metallic layer is clamped vertically, for example, by two projections facing each other and formed in the tool in such a way that the first cavity and/or the second cavity are locally sealed in order to impede overmolding of the elastomer compound. It is possible that the metallic layer is locally thinned out by the two mutually-facing projections when the tool is closed.

The elastomer compound, for example the first elastomer compound and/or the second elastomer compound, can be injected into the respective cavity at an injection pressure of at least 500 bar and/or at most 1000 bar.

The method can be carried out in particular using the tool described above. Features of the method can be combined with features of the tool and vice versa. This also applies analogously to features of the separator plate and features of the method.

The method described here is particularly suitable for producing the separator plate described above or is designed for this purpose. Features that have only been described in connection with the separator plate can be combined with the method and vice versa.

According to a fourth aspect, an electrolyser is proposed. The electrolyser comprises a plurality of stacked separator plates of the type described above. In one embodiment, water is the reaction medium, while hydrogen and oxygen are the product media.

Embodiments of the separator plate, the tool, the method and the electrolyser are shown in the attached figures and are explained in more detail in the following description.

### BRIEF DESCRIPTION OF THE FIGURES

FIG. 1 shows a schematic of an exploded view of a single cell of an electrolyser with two separator plates.

FIG. 2 shows a schematic top view of a metallic layer of a separator plate.

FIG. 3 shows a schematic section through a partial region of a separator plate according to one embodiment

FIG. 4 shows a schematic section through a partial region of a separator plate according to a further embodiment.

FIG. 5 shows a schematic section through a part of a tool for manufacturing the separator plate according to FIG. 3.

FIG. 6 shows a schematic section through a part of a tool for manufacturing the separator plate according to FIG. 4.

FIG. 7 shows a schematic section through a partial region of a tool for producing a further separator plate.

FIG. 8 shows a detail A from FIG. 7.

FIG. 9 shows the embodiment of FIG. 8 with lines drawn in.

### DETAILED DESCRIPTION

Here and in the following, recurring features in different figures are each designated with the same or similar reference signs.

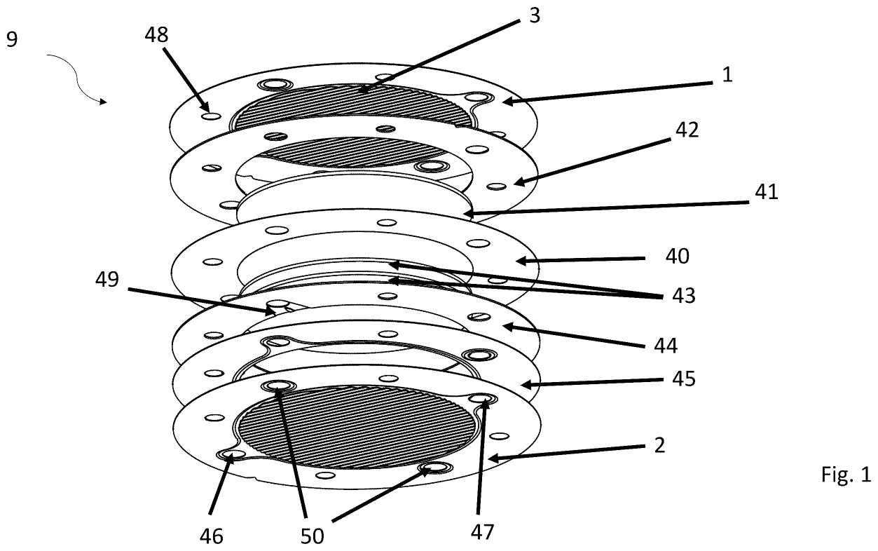

FIG. 1 shows an exploded view of an individual electrochemical cell 9, wherein the cell 9 is part of an electrolyser. Electrolysers typically comprise a large number of stacked individual cells 9. The individual cell 9 comprises two separator plates 1 and 2, two cell frames 42 and 44, a sealing layer 45, and a membrane electrode assembly 40 with media diffusion structures 41 and 43. For example, the media diffusion structure 43 comprises layers of carbon fleece, while the media diffusion structure 41 comprises metal, e.g. titanium. Here, the separator plate 1 is arranged, for example, on the anode side of the individual cell 9. In the exemplary embodiment shown, the separator plate 2 is arranged on the cathode side of the individual cell 9. The individual layers are compressed together to form an individual cell. The individual layers each have fluid passages 46, 47, 50, arranged in alignment one above the other, for the inward and outward passage of water, oxygen and hydrogen, as well as positioning holes 48.

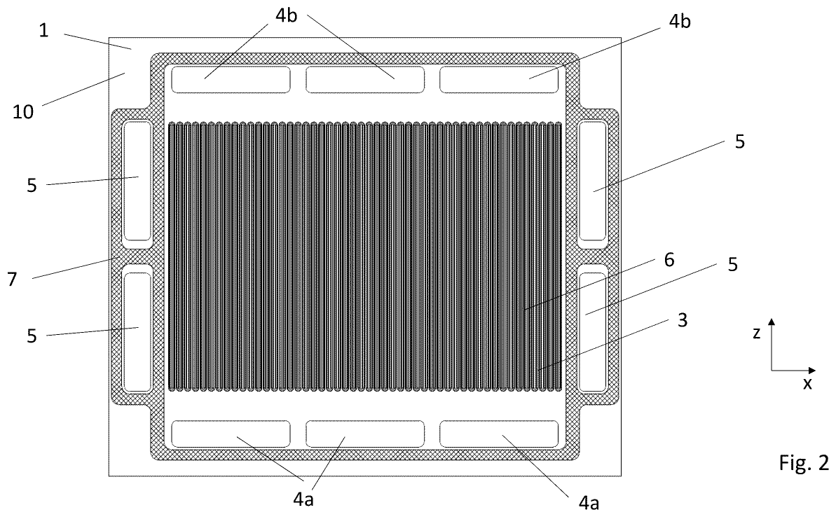

A flow field of the separator plate 2 is defined by projecting the cell frame 44 onto the separator plate 2. A flow field 3 of the separator plate 1 is defined by projecting the cell frame 42 onto the separator plate 1. The cell frame 42 has distribution channels (not shown) for distributing the water that is fed in. The through-openings 46, 47 are fluidically connected to the flow field 3 so that a medium can be routed from the through-opening 46 to the flow field 3, or from the flow field 3 to the through-opening 47. When a potential is applied, hydrogen (or oxygen) can be generated in the electrolyser from the supplied water. This can be discharged through the distribution channels 49 in the cell frame 44. It can then leave the cell through the through-openings 50. While the separator plates 1 shown in FIG. 1 have a round outer contour, other shapes are also possible. For example, the separator plates 1, 2 can have a rectangular outer contour (see also FIG. 2).

The separator plates 1, 2 in FIG. 1 are exemplary separator plates according to the prior art.

As already indicated above, a pressure difference between the environment and the interior of the electrochemical cell 9 can be more than 20 bar. The pressure on the product side, for example the hydrogen side, is often up to 40 bar, while the pressure on the reactant side, for example the water side, is only up to 2 bar. Sealing structures are therefore provided to seal the individual regions from each other.

For example, elastomer seals are used, which are arranged around the regions to be scaled, e.g. flow field 3 or through-openings 46, 47, 50. The elastomer seal is not usually provided over the entire surface, but only in the regions of the separator plate to be sealed.

FIG. 2 shows a schematic top view of a separator plate 1 for an electrolyser. The separator plate 1 comprises a metallic layer 10, which for example consists at least predominantly or completely of titanium or stainless steel or alloys thereof. The metallic layer 10 can have a thickness of at least 0.1 mm and/or at most 0.8 mm. The separator plate 1 has a flow field 3, which is designed to distribute the water supplied from the through openings 4a over as large an area as possible. Optional channel structures 6 are provided in the flow field 3 for this purpose. The through-openings 5 are designed to discharge hydrogen, whereby on the side of the separator plate shown the fluid through-openings 5 are surrounded by an elastomer seal 7. The elastomer seal 7 ensures that the water cannot escape and that hydrogen or ambient air cannot enter.

Separator plates of fuel cells are often designed in two layers so that each layer can be processed individually, such as embossed, surface-treated, injection-molded, etc. Separator plates 1, 2 of electrolysers, on the other hand, are often designed as a single layer. For this reason, scaling elements 7 of separator plates in electrolysers must be provided on both sides of a single layer. In addition, the arrangement of sealing elements in a separator plate of an electrolyser leads to an accumulation of different sealing elements in a confined space. The sealing elements are also arranged alternately to seal both sides of the separator plate. The separator plate is therefore highly complex when it comes to sealing the through-openings or the flow field, both due to the small distance between the sealing elements and the alternating arrangement.

To produce the elastomer seal 7, the metallic layer 10 of the separator plate 1 is typically placed in a tool for injection molding. After closing the tool, an elastomer compound is injected onto the layer 10 to form the elastomer seal 7. It can sometimes be difficult to inject the metallic layer 10 with elastomer compound on both sides at the same time. The elastomer fronts often run at different speeds on both sides of the metallic layer 10, which can result in an imbalance of forces. Theoretically, each side of separator plate 1 can be injected individually. However, it takes a long time for the elastomer compound to harden. It is therefore desirable if both sides of the metallic layer 10 can be injected at the same time. In addition, it is sometimes difficult to seal the metallic layer 10 of the separator plate 1 at high injection pressures of typically at least 500 bar in the injection tool.

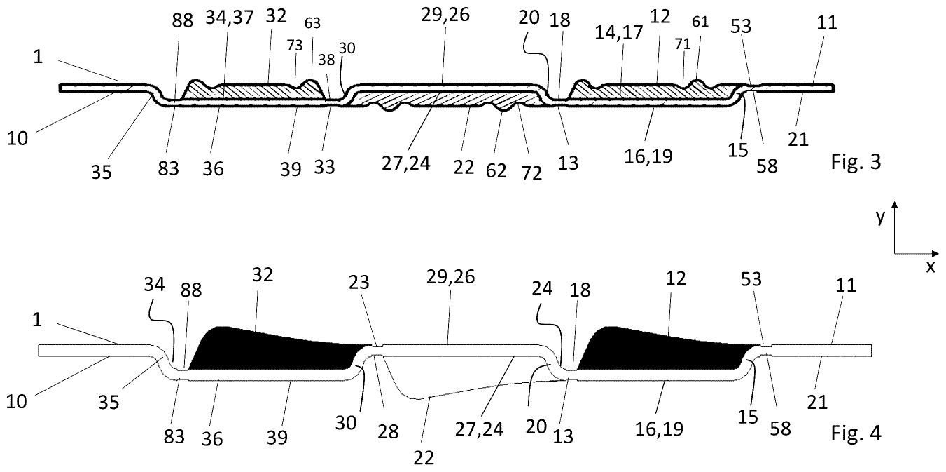

The present disclosure was conceived to solve these problems, at least in part. The present disclosure is described in more detail with reference to the embodiments shown in FIGS. 3-9.

FIGS. 3 and 4 each show a separator plate 1 of an electrolyser with a metallic layer 10. Typically, the metallic layer 10 is a metal sheet made of titanium and/or stainless steel. The metallic layer typically has a thickness of at least 0.1 mm and/or at most 0.8 mm. The separator plate 1 is often designed as a single-layer plate; there are therefore no metallic layers other than the metallic layer 10 shown.

The metallic layer 10 has a first side 11 and a second side 21 opposite the first side 11. Further, the separator plate 1 comprises a first elastomeric seal 12 which is arranged in a channel-shaped first groove 14 on the first side 11 of the metallic layer 10, wherein the first groove 14 forms a first web 16 on the second side 21 of the metallic layer 10. In addition, the separator plate 1 has a second elastomer seal 22, which is arranged in a channel-shaped second groove 24 on the second side 21 of the metallic layer 10, wherein the second groove 24 forms a second web 26 on the first side 11 of the metallic layer 10.

The second web 26 is adjacent to the first groove 14 and the first web 16 is adjacent to the second groove 24, so that the first groove 14 and the second groove 24 have a common side wall 20. The first groove 14 also has a further side wall 15. Thus, the first groove 14 is laterally delimited by the side walls 15, 20.

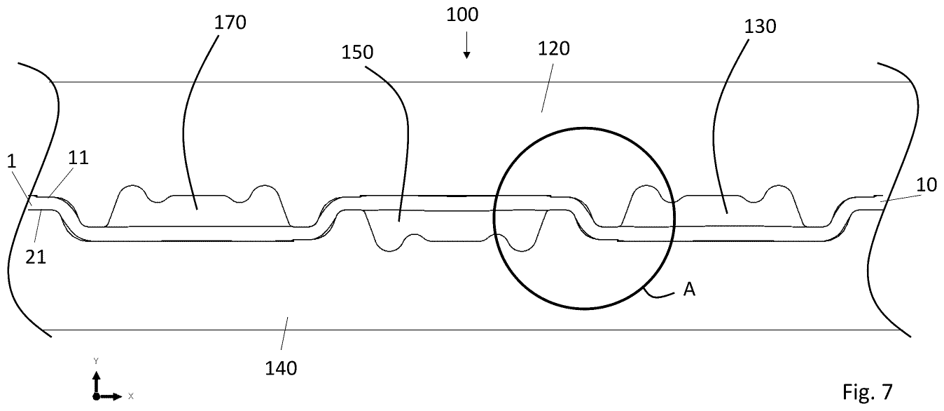

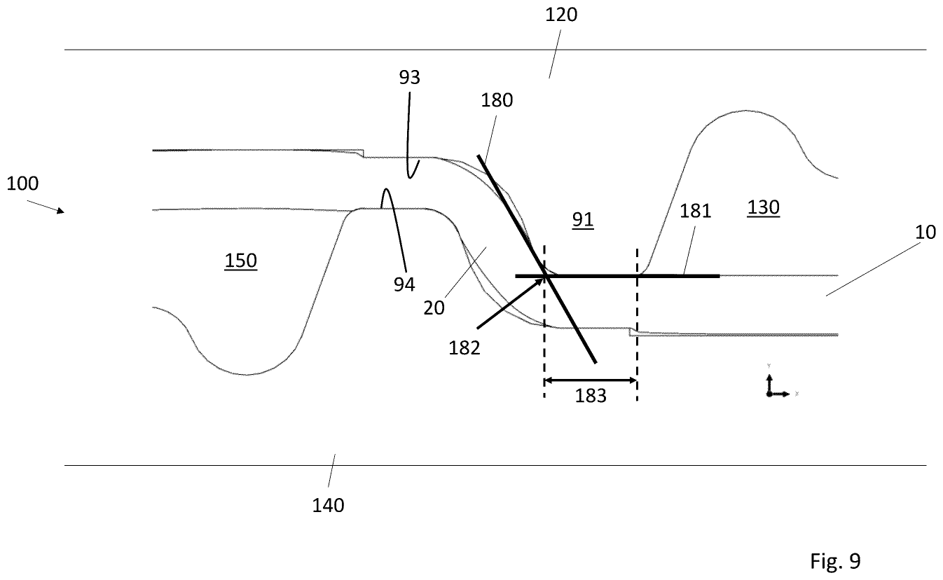

As shown in FIGS. 3-9, the first elastomer seal 12 is spaced from the common side wall 20. The elastomer seal 12 therefore does not completely fill the groove 14 in the lateral direction, as a result of which a region of the first groove 14 is recessed. The lateral direction is indicated by the x-direction in the figures. The first elastomer seal 12 can lie against the further side wall 15, see FIGS. 3-6, or be laterally spaced from it, see FIG. 7. The spacing is explained below with reference to FIG. 9.

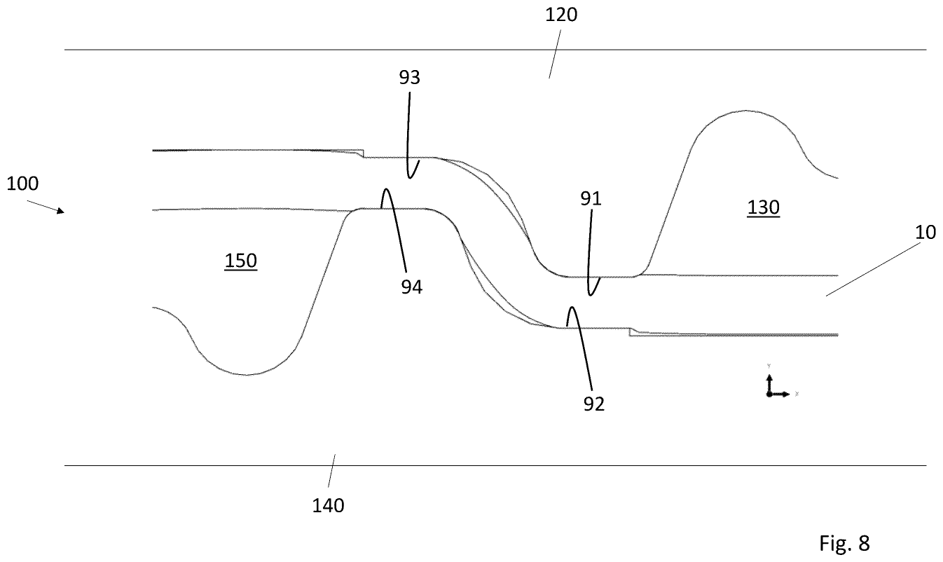

In the embodiment examples of FIGS. 3-6, the second elastomer seal 22 is in contact with the common side wall 20. Alternatively, the second elastomer seal 22 can also be spaced from the common side wall 20, see FIGS. 7 and 8.

Optionally, the separator plate 1 can also have a third elastomer seal 32, which is arranged in a channel-shaped third groove 34 on the first side 11 of the metallic layer 10, wherein the third groove 34 forms a third web 36 on the second side 21 of the metallic layer 10.

It may be provided that the third web 36 is adjacent to the second groove 24 on the second side 21 and the second web 26 is adjacent to the third groove 34 on the first side 11, so that the second groove 24 and the third groove 34 have a common side wall 30.

The second elastomer seal 22 can lie against the common side wall 30, see FIG. 3, or be spaced apart from it, see FIG. 4. The third elastomer seal 32 can lie against the common side wall 30, see FIG. 4, or be spaced apart from it, see FIG. 3. It may also be provided that both elastomer seals 22, 32 are spaced apart from the common side wall, see FIG. 7. Where the elastomer seals 12, 22, 32 are spaced from the side wall 20 or 30, a gap is formed between the side wall 20, 30 and the corresponding elastomer seal 12, 22, 32.

At least one, several or all elastomer seals 12, 22, 32 can be configured to seal the flow field 3 and/or the through-openings 4, 5 of the separator plate 1 at least in certain regions.

If provided, the third groove 34 also often has a further side wall 35. Thus, the third groove 34 is laterally delimited by the side walls 30, 35. The second groove 24 is laterally delimited by the side walls 20 and 30. Depending on the embodiment, the third elastomer seal 32 can be spaced apart from the further side wall 35 or lie against it.

Each groove 14, 24, 34 also has a floor 17, 27, 37 on which the respective elastomer seal 12, 22, 32 extends in the longitudinal direction of the corresponding groove 14, 24, 34. Furthermore, each web 16, 26, 36 has a roof 19, 29, 39 which extends like a plateau and forms the largest deflection of the web 16, 26, 36 in the height direction, i.e. y-direction, perpendicular to a plate plane. The respective web roof 19, 29, 39 has a substantially flat or slightly convex cross-section perpendicular to the longitudinal direction and extends in the longitudinal direction of the elastomer seal 12, 22, 32. Accordingly, the respective groove floor 17, 27, 37 extends flat or substantially flat or slightly concave between the side walls 15, 20 or 20, 30 or 30, 35. The first groove 14 and/or the second groove 24 and/or the third groove 34 are usually substantially trapezoidal or rectangular in cross-section perpendicular to the longitudinal extension.

It may be provided that the floor 17 of the first groove 14 has an embossing 18 in the region where the first elastomer seal 12 is recessed, which extends in the longitudinal direction of the first groove 14 next to the first elastomer seal 12. Furthermore, in some embodiments, the separator plate 1 is designed in such a way that a roof 19 of the first web 16 has an embossing 13, wherein the embossing 13 of the web roof 19 and the embossing 18 of the groove floor 17 are arranged to overlap, so that the metallic layer 10 is thinner in the region of the overlapping embossings 13, 18.

Optionally, in an analogous manner, the floor 27 of the second groove 24 can have an embossing 28 in the region where the second elastomer seal 22 is recessed, which embossing 28 extends in the longitudinal direction of the second groove 24 next to the second elastomer seal 22, wherein a roof 29 of the second web 26 has an embossing 23, wherein the embossing 23 of the web roof 29 and the embossing 28 of the groove floor 27 are arranged to overlap, so that the metallic layer 10 is thinner in the region of the overlapping embossings 23, 28, cf. FIG. 4.

Optionally, in a similar manner, the floor 37 of the third groove 34 can have an embossing 38 in the region where the third elastomer seal 32 is recessed, which embossing 38 extends in the longitudinal direction of the third groove 34 next to the third elastomer seal 32, wherein a roof 39 of the third web 36 has an embossing 33, wherein the embossing 33 of the web roof 39 and the embossing 38 of the groove floor 37 are arranged to overlap, so that the metallic layer 10 is thinner in the region of the overlapping embossings 33, 38.

In addition, the metallic layer 10 can have respective embossings 53, 58 next to the side wall 15 and next to the first elastomer seal 12 on both sides 11, 21, which are arranged opposite each other, so that here too the metallic layer 10 is thinner in the region of the overlapping embossings 53, 58.

Thinner therefore means that the thickness of the metallic layer 10 in this region is less than in abutting, non-embossed regions. The metallic layer 10 can, for example, be at least 10% and/or at most 30% thinner than the abutting regions. For example, the metal sheet can be nominally 40 μm thinner in the thinner region. The embossings mentioned in this document can also be understood as local depressions in the metallic layer 10, whereby opposing or overlapping depressions form the thinning of the metallic layer 10.

In general, a sequence of N elastomer seals can therefore have at least N+1 thinned-out regions in the metallic layer 10, which extend next to the elastomer seals and along their longitudinal directions. In the embodiments of FIGS. 3, 4 with N=3 elastomer seals, there are therefore 4 thinned-out regions of the metallic layer 10.

The grooves 14, 24, 34 and webs 16, 26, 36 formed in the separator plate 1 are optionally formed by embossing, hydroforming and/or deep drawing, optionally before the elastomer seals 12, 22, 32 are formed, and are therefore usually integral components of the metallic layer 10.

The first elastomer seal 12 and/or the second elastomer seal 22 and/or the third elastomer seal 32 can be formed from fluororubber, FKM, and/or ethylene-propylene-diene rubbers, EPDM and/or a silicone. The materials of the elastomer seals 12, 22, 32 can be different or the same. It is also possible that the elastomer seals 12, 32 arranged on the first side 11 of the metallic layer 10 are formed from the same material, but differ from the material of the elastomer seal 22 arranged on the second side 21 of the metallic layer 10.

As shown in FIGS. 3, 4, 5, 7 and 8, the elastomeric seals 12, 22, 32 often have at least one scaling lip 61, 62, 63, optionally two sealing lips 61, 62, 63, which extend in the longitudinal direction of the elastomeric seal 12, 22, 32. The respective scaling lip 61, 62, 63 can have a protrusion from the adjacent web 16, 26, 36, so that the sealing lip 61, 62, 63 protrudes from the groove 14, 24, 34. Optionally, a depression 71, 72, 73 can be formed in the elastomer seal 12, 22, 32 adjoining the sealing lip, which extends laterally next to the sealing lip 61, 62, 63. Depressions can also be formed in the elastomer seal 12, 22, 32 on both sides of the scaling lip 61, 62, 63, cf. for example sealing lips 62 of the second elastomer seal 22 with depressions 72 in FIG. 3.

Some features of the separator plate 1 result directly from the manufacturing method in an injection tool. This is explained further below.

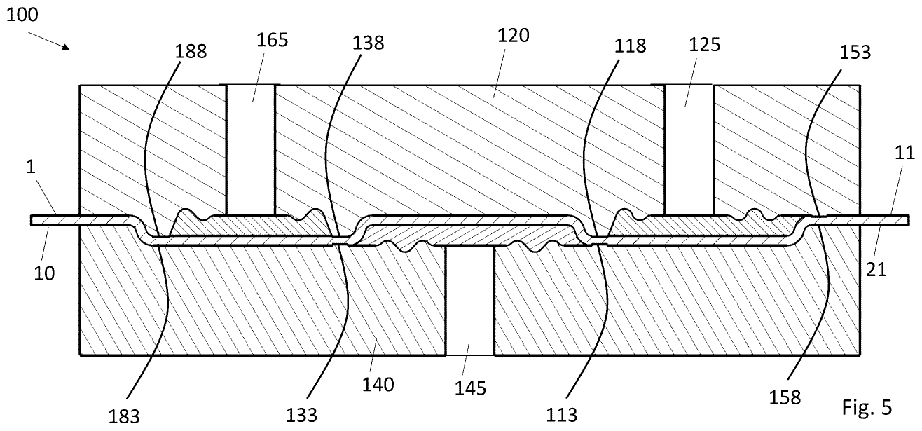

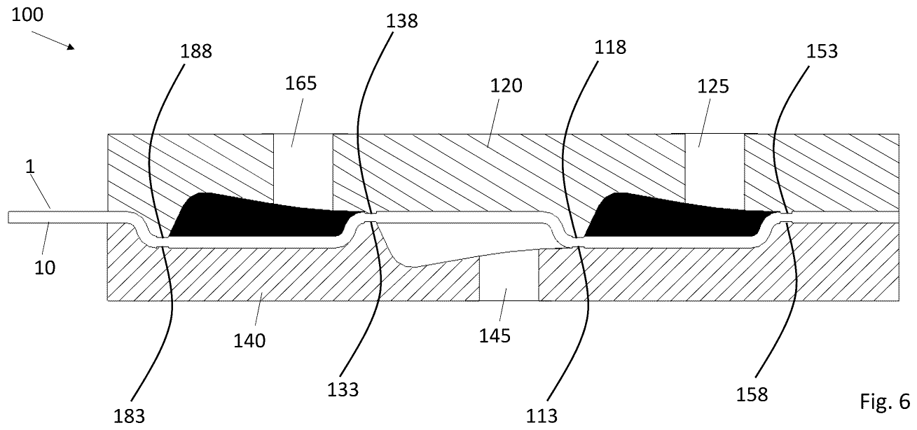

FIGS. 5 and 6 show a section of a tool 100 for manufacturing the separator plate 1. The tool 100 has a first tool component 120 with a first injection channel 125 for supplying a first elastomer compound. In addition, the tool has a second tool component 140 with a second injection channel 145 for supplying a second elastomer compound. Optionally, the first tool component 120 has a third injection channel 165 for supplying a third elastomer compound. The present disclosure is not limited to three injection channels; rather, further injection channels can be provided. Often, however, no injection channels are arranged in a region of one tool half that overlaps with a region of the other tool half in a direction transverse to the closing direction of the tool, wherein an injection channel is located in the overlapping region of the other tool half. The injection channels 125, 145, 165 are thus optionally not arranged directly opposite one another (not overlapping), but alternately in the first tool half and the second tool half.

Of the tool components 120, 140, at least one tool component is movable relative to the other tool component. The tool components 120, 140 are configured to receive the metallic layer 10 in an open state and to inject the metallic layer 10 on both sides in a closed state. Before it is received, the metallic layer 10 usually already has the grooves 14, 24, 34 and the webs 16, 26, 36. The metallic layer 10 is therefore generally already pre-formed or pre-embossed when it is placed in the tool 100. However, the embossings 13, 18, 23, 28, 33, 38, 53, 58 of the metallic layer 10 are produced in the tool 100, see below.

The tool components 120, 140 are configured such that when the tool 100 is closed, a first cavity 130 is formed between the first tool component 120 and the first groove 14 and a second cavity 150 is formed between the second tool component 140 and the second groove 24. The first elastomer compound from the first injection channel 125 is introduced into the first cavity 130 to form the first elastomer seal 12. Further, the second elastomer compound is introduced from the second injection channel 145 into the second cavity 150 to form the second elastomer seal 22. In addition, the third elastomer compound is introduced from the third injection channel 165 into the third cavity 170 to form the third elastomer seal 32. It should be noted that the first elastomer compound, the second elastomer compound and the third elastomer compound may be the same or different, depending on the requirements and use of the separator plate 1. The injection channels 125, 145, 165 are designed to inject the respective elastomer compound into the corresponding cavity 130, 150, 170 under a pressure of at least 500 bar or at most 1000 bar, optionally about 800 bar.

The flat or slightly curved web roofs 19, 29, 39 lie against flat or correspondingly slightly curved surfaces in the tool halves 120, 140. Furthermore, depending on the shape of the elastomer seal 12, 22, 32, such as sealing lips 61, 62, 63 or depressions 71, 72, 73, the tool halves 120, 140 or the cavities 130, 150, 170 of the tool halves 120, 140 may have corresponding complementary shapes.

The first tool component 120 may have a first projection 118 and the second tool component 140 may have a second projection 113. The projection 118 and the projection 113 face each other in the closing direction of the tool 100 and are designed to clamp the metallic layer 10 in the tool 100 during the injection process. By clamping the metallic layer 10 between the two projections 113, 118, the first cavity 130 and/or the second cavity 150 can be locally sealed in order to impede overmolding of the first and/or second elastomer compound. Due to the contact pressure of the tool 100, the projections 118, 113 create the embossings 13 and 18 in the metallic layer 10. The first projection 118 may, for example, adjoin the first cavity 130 and the groove floor 17 of the metallic layer 10, while the second projection 113 may, for example, be adjacent to the second cavity 150 and the web roof 19.

Optionally, the first tool component 120 may have a projection 153 and the second tool component 140 may have a projection 158. The projection 153 and the projection 158 face each other in the closing direction of the tool 100 and are designed to clamp the metallic layer 10 in the tool 100 during the injection process. By clamping the metallic layer, the first cavity 130 can be locally sealed to impede or at least reduce overmolding of the elastomer compound. Due to the contact pressure of the tool 100, the projections 153, 158 create the embossings 53 and 58 in the metallic layer 10. The projection 153 may adjoin the first cavity 130 and extends laterally adjacent to the first groove 14.

The first tool component 120 may further comprise a projection 138 and the second tool component 140 may comprise a projection 133. The projection 138 and the projection 133 face each other in the closing direction of the tool 100 and are designed to clamp the metallic layer 10 in the tool 100 during the injection process. By clamping the metallic layer 10 in place, the third cavity 170 and/or the second cavity 150 can be sealed locally to impede overmolding of the elastomer compound. Due to the contact pressure of the tool 100, the projections 138, 133 create the embossings 33 and 38 in the metallic layer 10. The projection 138 may be adjacent to the third cavity 170 and adjoin the groove floor 37. The projection 133 may adjoin the second cavity 150 and abut the web roof 39.

Optionally, the first tool component 120 may have a projection 188 and the second tool component 140 may have a projection 183. The projection 183 and the projection 188 face each other in the closing direction of the tool 100 and are designed to clamp the metallic layer 10 in the tool 100 during the injection process. By clamping the metallic layer 10 in place, the third cavity 170 can be sealed locally to impede overmolding of the elastomer compound in the region. Due to the contact pressure of the tool 100, the projections 183, 188 create the embossings 83 and 88 in the metallic layer 10. The projection 188 may adjoin the third cavity 170 and abut the groove floor 37. The projection 183 can lie against the web roof 39.

The projections 113, 118, the projections 133, 138, the projections 153, 158 and the projections 183, 188 each form a pair of projections. Each pair of projections thus seals at least one cavity 130, 150 or 170 in the tool 100 from one side and can cause thinning out of the metallic layer 10. Certain pairs of projections can be configured for the simultaneous sealing of two cavities, cf. pairs of projections 133-138 and pairs of projections 113-118, which are arranged between the cavities to be sealed.

Depending on where the projections are located in the tool, the resulting elastomer seal 12, 22, 32 will lie against the side wall 15, 20, 30, 35 of the groove 14, 24, 34 or be spaced from the side wall 15, 20, 30, 35 of the groove 14, 24, 34. Accordingly, the embossings 13, 18, 23, 28, 33, 38, 53, 58 can be formed in the floor of the groove or in the roof of the web.

FIG. 7 shows a further embodiment of a tool 100 and a separator plate 1 before the metallic layer 10 is molded on. To avoid unnecessary repetition, only detail A in FIG. 7, which is shown enlarged in FIG. 8, will be discussed here.

In detail A of FIG. 8, projections 91, 92, 93, 94 can be seen. The projections 91 and 92 and the projections 93 and 94 are arranged opposite each other and work together to hold the interposed metallic layer 1 in the tool 100 and to seal the cavities 130, 150. Thus, each of the cavities 130, 150, 170 shown in FIGS. 7, 8 is sealed on both sides by pressing on the metallic layer 1 by pairs of projections 91-92 and 93-94. This allows the cavities 130, 150, 170 to be sealed particularly well. The resulting separator plate 1 has elastomer seals 12, 22, 32, which are each spaced from both side walls of the corresponding grooves 14, 24, 34. There are therefore a total of 2*N pairs of projections in the tool for N elastomer seals, namely two pairs of projections per cavity 130, 150, 170 or per elastomer seal 12, 22, 32. This results in 2*N thinned-out regions in the metallic layer. In this case, each pair of projections seals a cavity in the tool 100 from one side.

A total of at least N+1 and/or at most 2*N pairs of projections are thus provided in the tool 100, where N describes the number of elastomer seals 12, 22, 32 or the number of cavities in the tool 100.

The projections of each pair of projections shown in FIGS. 3-8 may have a minimum distance in the vertical direction—i.e. in the y-direction or closing direction of the tool 100—which is at least 10% less than the thickness of the metallic layer 10.

FIG. 9 shows the embodiment of FIG. 8, with additional lines drawn in. On the one hand, a tangent 180 is drawn from a corner radius of the rounded projection 91. The tangent 180 touches the projection 91 at the point where a concave region of the projection 91 changes into a convex region, i.e. where the function of the second derivative has a change of sign. Furthermore, an extension of the flat upper edge of the projection 91 is shown as line 181. This line 181 can also be described as an extension of the plate top edge of layer 10. Lines 180 and 181 intersect at an intersection point 182. The distance 183 from this intersection point 182 to the beginning of the elastomer 130 is a measure of the minimum distance between the elastomer 130 and the side wall 20. For example, the distance can be at least 0.2 mm and/or at most 0.5 mm. With a thickness in an unembossed region of the metallic layer 10 of 0.2 mm, this distance can be around 0.5 mm, for example. This distance 183 may apply to exactly one, at least one, a plurality or any of the elastomer/sidewall-pairings shown.

With the tool 100 described above, a method comprising the following steps can be carried out:
providing a metallic layer 10 having a first side 11 and a second side 21 opposite the first side 11, the metallic layer 10 having a channel-shaped first groove 14 on its first side 11, wherein the groove forms a first web 16 on the second side 21 of the metallic layer 10, wherein the metallic layer 10 has on its second side 21 a channel-shaped second groove 24 which forms a second web 26 on the first side 11 of the metallic layer 10, wherein the second web 26 adjoins the first groove 14 and the first web 16 adjoins the second groove 24, so that the first groove 14 and the second groove 24 have a common side wall 20,
inserting the metallic layer 10 between a first tool component 120 and a second tool component 140 of a tool 100,
closing the tool 100,
forming a first cavity 130 between the first groove 14 and the first tool component 120 and forming a second cavity 150 between the second groove 24 and the second tool component 140 in the closed state of the tool,
injecting a first elastomer compound into the first cavity 130 and of a second elastomer compound into the second cavity 150 from an injection channel 125, 145 located in each respective tool component 120, 140, wherein the injection of the first elastomer compound into the first cavity 130 and the injection of the second elastomer compound into the second cavity 150 takes place in parallel—i.e. simultaneously—or at least partially in parallel,
forming the first elastomeric seal 12 by curing the first elastomer compound in the first cavity 130 associated with the first channel-shaped groove 14 and the second elastomeric seal 22 by curing the second elastomer compound in the second cavity 150 associated with the second channel-shaped groove 24, wherein the first elastomeric seal 12 is spaced from the common side wall 20 and is recessed in this region of the first groove 14.

When the tool 100 is closed, the metallic layer 10 is clamped by two mutually-facing projections formed in the tool 100 in such a way that the first cavity 130 and/or the second cavity 150 are locally sealed in order to impede or reduce overmolding of the elastomer compound from the cavity 130, 150. Typically, the metallic layer 10 is locally thinned out by the two mutually-facing projections when the tool 100 is closed.

For the manufacture of the third elastomer seal 32, reference is made accordingly to the above remarks on the tool 100.

It should also be mentioned that features of the separator plates 1, 2 shown in FIGS. 1 and 2 can be combined with the features of the separator plates shown in FIGS. 3-8, provided the features are not mutually exclusive.

### LIST OF REFERENCE SIGNS

1 separator plate
2 separator plate
3 flow field
4a, 4b fluid passage opening
5 fluid passage opening
6 channel structures
7 elastomer seal
9 electrochemical cell
10 metallic layer
11 first flat side
12 first elastomer seal
13 embossing
14 first groove
15 side wall
16 first web
17 groove floor
18 embossing
19 web roof
20 common side wall
21 second flat side
22 second elastomer seal
23 embossing
24 second groove
26 second web
27 groove floor
28 embossing
29 web roof
30 common side wall
32 third elastomer seal
33 embossing
34 third groove
35 side wall
36 third web
37 groove floor
38 embossing
39 web roof
40 membrane electrode assembly
41 media diffusion structure
42 cell frame
43 media diffusion structure
44 cell frame
45 sealing layer
46 fluid passage opening
47 fluid passage opening
48 positioning hole
49 hydrogen distribution channels
50 hydrogen passage openings
53 embossing
58 embossing
61 sealing lip
62 sealing lip
63 sealing lip
71 depression
72 depression
73 depression
83 embossing
88 embossing
91 projection
92 projection
93 projection
94 projection
100 tool
113 projection
118 projection
120 first tool component
123 projection
125 first injection channel
128 projection
130 first cavity
133 projection
138 projection
140 second tool component
145 second injection channel
150 second cavity
153 projection
158 projection
165 third injection channel
170 third cavity
180 tangent of corner radius
181 extension of the plate top edge
182 intersection point of lines 180, 181
183 spacing

1. A separator plate for an electrolyser, comprising:
a metallic layer with a first side and a second side opposite the first side,
a first elastomer seal, which is arranged in a channel-shaped first groove on the first side of the metallic layer, wherein the first groove forms a first web on the second side of the metallic layer,
a second elastomer seal, which is arranged in a channel-shaped second groove on the second side of the metallic layer, wherein the second groove forms a second web on the first side of the metallic layer,
wherein the second web adjoins the first groove and the first web adjoins the second groove, so that the first groove and the second groove have a common side wall,
wherein the first elastomer seal is spaced from the common side wall and is recessed in a region of the first groove.

2. The separator plate according to claim 1, wherein a floor of the first groove has an embossing in a region where the first elastomer seal is recessed, wherein the embossing extends next to the first elastomer seal in a longitudinal direction of the first groove.

3. The separator plate according to claim 2, wherein a roof of the first web has a second embossing, wherein the second embossing of the roof and the embossing of the floor are arranged to be overlapping, so that the metallic layer is thinner in a region of the overlapping embossings.

4. The separator plate according to claim 1,
wherein the second elastomer seal is spaced from the common side wall and is recessed in a region of the second groove, or
wherein the second elastomer seal lies against the common side wall.

5. The separator plate according to claim 1, wherein the first groove is delimited by a further side wall,
wherein the first elastomer seal lies against the further side wall or
wherein the first elastomer seal is spaced from the further side wall and is recessed in a region of the further side wall.

6. The separator plate according to claim 1, wherein at least one of the first elastomer seal and the second elastomer seal has at least one sealing lip, which extends in a longitudinal direction of the elastomer seal and has a protrusion extending towards an adjoining web, wherein a depression is formed in the elastomer seal adjoining the sealing lip, wherein the depression extends laterally next to the sealing lip.

7. The separator plate according to claim 1, wherein the first groove and/or the second groove are substantially trapezoidal or rectangular in a cross-section perpendicular to a longitudinal extension.

8. The separator plate according to claim 1, wherein the first elastomer seal extends in a longitudinal direction of the first groove on a floor of the first groove and/or wherein the second elastomer seal extends in a longitudinal direction of the second groove on a floor of the second groove.

9. The separator plate according to claim 1, comprising
a third elastomer seal arranged in a channel-shaped third groove on the first side of the metallic layer, wherein the third groove forms a third web on the second side of the metallic layer, wherein the third web adjoins the second groove on the second side and the second web adjoins the third groove on the first side, so that the second groove and the third groove have a second common side wall,
wherein the third elastomer seal is spaced from the second common side wall and is recessed in a region of the second common side wall.

10. The separator plate according to claim 1, wherein the separator plate is configured as a single-layer plate, and the metallic layer is formed from titanium and/or stainless steel and/or has a thickness of at least 0.1 mm and/or at most 0.8 mm.

11. The separator plate according to claim 1, wherein the first elastomer seal and/or the second elastomer seal and/or the third elastomer seal is formed from fluororubber, FKM, and/or ethylene-propylene-diene rubbers, EPDM and/or a silicone.

12. The separator plate according to claim 1, wherein the first elastomer seal and/or the second elastomer seal and/or the third elastomer seal are molded onto the metallic layer.

13. The separator plate according to claim 9, wherein a floor of the third groove has an embossing in a region where the third elastomer seal is recessed, wherein the embossing extends next to the third elastomer seal in a longitudinal direction of the third groove, wherein a roof of the third web has a second embossing, wherein the second embossing of the roof and the embossing of the floor are arranged to overlap, so that the metallic layer is thinner in the region of the overlapping embossings.

14. A tool for manufacturing the separator plate according to claim 1, comprising:
a first tool component with a first injection channel for supplying a first elastomer compound,
a second tool component with a second injection channel for supplying a second elastomer compound,
wherein of the first tool component and the second tool component at least one tool component is movable relative to the other tool component and the first tool component and the second tool component are configured in an open state to receive the metallic layer and are designed in a closed state for injection molding on both sides of the metallic layer,
wherein the first tool component and the second tool component are configured such that, in the closed state, a first cavity is formed between the first tool component and the first groove and a second cavity is formed between the second tool component and the second groove, wherein the first elastomer compound can be introduced into the first cavity from the first injection channel for forming the first elastomer seal and the second elastomer compound can be introduced into the second cavity from the second injection channel to form the second elastomer seal.

15. The tool according to claim 14, wherein the first tool component has a first projection and the second tool component has a second projection, wherein the first projection and the second projection face each other and are designed to clamp the metallic layer in the tool during an injection process and to locally seal the first cavity and/or the second cavity in order to impede overmolding of the first elastomer compound and/or the second elastomer compound.

16. The tool according to claim 15, wherein the first projection and the second projection of the first tool component and the second tool component are configured to locally thin out the metallic layer arranged between the first projection and the second projection, wherein a minimum distance between the first projection and the second projection in a closing direction of the tool is at least 10% less than a thickness of the metallic layer.

17. A method of manufacturing a separator plate for an electrolyser, comprising the steps of:
providing a metallic layer having a first side and a second side opposite the first side, the metallic layer having a channel-shaped first groove on its first side, wherein the first groove forms a first web on the second side of the metallic layer, wherein the metallic layer has on its second side a channel-shaped second groove, which forms a second web on the first side of the metallic layer, wherein the second web adjoins the first groove and the first web adjoins the second groove, so that the first groove and the second groove have a common side wall,
inserting the metallic layer between a first tool component and a second tool component of a tool,
closing the tool,
forming a first cavity between the first groove and the first tool component and forming a second cavity between the second groove and the second tool component in a closed state of the tool,
injecting an elastomer compound into the first cavity and into the second cavity from an injection channel located in each respective tool component, wherein injecting into the first cavity and injecting into the second cavity takes place in parallel or at least partially in parallel,
forming a first elastomeric seal by curing the elastomer compound in the first cavity associated with the first groove and a second elastomeric seal by curing the elastomer compound in the second cavity associated with the second groove, wherein the first elastomeric seal is spaced from the common side wall and is recessed in a region of the first groove.

18. The method according to claim 17, wherein the metallic layer is clamped by two mutually facing projections formed in the tool in such a way that the first cavity and/or the second cavity are locally sealed in order to impede overmolding of the elastomer compound.

19. The method according to claim 18, wherein the metallic layer is locally thinned out by the two mutually facing projections during closing of the tool.

20. An electrolyser comprising a plurality of stacked separator plates according to claim 1.
